(19) United States
(12) Patent Application Publication
(10) Pub. No.: US 2026/0246615 A1
(43) Pub. Date: Aug. 20, 2026

(54) PROTECTED ASSOCIATION FRAME IN PRE-ASSOCIATION SECURITY NEGOTIATION

(71) Applicant: MEDIATEK INC, Hsinchu City (TW)

(72) Inventor: Rudra Pratap Shahi, Noida (IN)

(73) Assignee: MEDIATEK INC, Hsinchu City (TW)

(21) Appl. No.: 19/095,054

(22) Filed: Mar. 31, 2025

(30) Foreign Application Priority Data
Feb. 17, 2025 (IN) 202521013497

(51) Int. Cl. H04L 9/08; H04L 9/32

(52) U.S. Cl. CPC H04L 9/0819; H04L 9/3236

(57) ABSTRACT

A method for associating a client device (STA) with an access point (AP) includes: utilizing the STA to generate a message integrity check (MIC) for an association request frame according to at least a Pairwise Transient Key (PTK) generated during an authentication procedure between the STA and the AP; appending the generated MIC to the association request frame, and sending the association request frame to the AP; and utilizing the AP to validate the STA according to the MIC in the association request frame.

### BACKGROUND

The present invention relates to an association procedure in the 802.11az protocol, and more particularly, relates to providing a protected association frame.

Wireless communications between an access point (AP) and a station (STA) are subject to spoofing attacks, where a ‘man in the middle’ pretends to be one of the two devices in order to receive data sent between the AP and the STA. To prevent such breaches of security, wireless communications standards provide protection such as data encryption, secure password keys, and message integrity checks (MIC).

802.11az provides an extra level of protection called pre-association security negotiation (PASN). When a client device (STA) connects with an AP in order to carry out wireless communications, the stages involved are authentication, association, and 4-way handshaking. During the authentication stage, an STA will send a PASN frame to an AP. In response, the AP will derive an encryption key PTK (Pairwise Transient Key) from a Pairwise Master Key (PMK) contained within the AP, wherein the PMK is derived internally by the AP from wrapped data sent in an authentication frame. The AP further generates a MIC and appends the MIC to an authentication frame which is sent to the STA. The STA validates the MIC and generates its own PMK and PTK, and responds to the AP. Both sides store the PMK and PTK as, respectively, PMKSA and PTKSA (secure association). The use of the generated PMK and MIC ensures that the STA is a valid STA. Further, upon re-association, the PTK can be retrieved from the PTKSA by both sides, and the MIC can be generated using this retrieved PTK and used for connection.

During the association stage, however, the AP and STA are still subject to man in the middle attacks. A spoofed association request may be sent to the AP, leading the AP to respond with a valid association response such that the procedure will enter the 4-way handshaking stage and EAPOL (Extensible Authentication Protocol over LAN). During this stage, MICs are appended to the association request/response frames, so that the AP can verify whether received messages are corrupted or not. The MICs may be 16 bits or 24 bits depending on the Authentication and Key Management (AKM) that is being used. MICs are calculated from the PTK, hash values, SAE data, RSNXE or FT data of the frame, thus ensuring the MIC is unique to each party. As the data sent by the man in the middle will have a different hash value from that of data sent by the authenticated STA, the calculated MIC will not match the MIC previously derived by the AP. The AP will therefore determine that the STA is not valid, and further communications with said STA will be blocked.

As demonstrated above, the use of the MIC tag during pre-association can prevent spoofed attacks; however, when the AP receives a spoofed association request, the invalid STA will only be discovered during the handshaking stage, which consumes network time. When a group contains a large number of STAs, the latency increase will be significant. Further, 4-way handshaking carried out for an invalid STA will block valid STAs from connecting with the AP at that point.

After communications have successfully been established between an AP and a valid STA, the STA may roam to a different AP. Refer to FIG. 1, which illustrates a roaming STA re-associating to a first AP. As illustrated in the diagram, the WPA3 protocol enables the PMK IDs of the exchange between the AP and STA to be cached. When the roaming STA sends the re-association request to the first AP, due to the PMK caching, the standard authentication procedure can be skipped. As it is possible that the re-association request is a spoofed request, however, the AP has to trigger a security authentication (SA) query in order to determine whether the STA is a valid STA. The SA query is encrypted so must first be decrypted before it can be processed. If an initial SA query fails, there will be a certain number of retries and timeouts. If there is no response, the AP will disconnect from the STA and connection must be attempted again with a different authentication procedure. This takes a certain amount of time which increases the network latency, making this an inefficient roaming method.

In all of the above cases, this increase in latency can cause significant inconvenience for a user, particularly when a time-sensitive application is required. In addition, roaming time is not effectively used, and there is unnecessary processing of packets, which wastes CPU power.

### SUMMARY

This in mind, the invention aims to provide a method for decreasing the network latency during an association procedure between a STA and an AP.

The invention further provides an association frame comprising a message integrity check (MIC) tag, which can decrease network latency during an association procedure between a STA and an AP.

A further advantage of the invention is that it provides protection against spoofed association requests and other attacks during the pre-association phase.

A further advantage is that association requests can be validated using cached PTKs to validate the MIC, which reduces roaming time and enables transition between APs. By removing the need for SA queries, latency is reduced.

In addition, the extension of PASN protection to the association request means that any initial communication between the AP and client device is protected, such that spoofers are unable to intercept or tamper with the association request, thereby protecting both the AP and client device from further attacks.

In accordance with an exemplary embodiment of the present invention, a method for associating a client device (STA) with an access point (AP) comprises: utilizing the STA to generate a message integrity check (MIC) for an association request frame according to at least a Pairwise Transient Key (PTK) generated during an authentication procedure between the STA and the AP; appending the generated MIC to the association request frame, and sending the association request frame to the AP; and utilizing the AP to validate the STA according to the MIC in the association request frame.

When the STA is validated by the AP, the method further comprises: utilizing the AP to generate a message integrity check (MIC) for an association response frame according to at least a Pairwise Transient Key (PTK) generated during the authentication procedure between the STA and the AP; appending the generated MIC to the association response frame, and sending the association response frame to the STA; and utilizing the STA to validate the AP according to the MIC in the association response frame.

The step of utilizing the STA to generate the message integrity check (MIC) further comprises: calculating a hash of the association request frame using group data, cipher data and authentication and key management data; generating the MIC according to the calculated hash and the PTK; generating a control value according to the type of data used to generate the MIC; and including the control value in the association request frame. The AP uses the control value and the MIC to validate the STA.

When the control value is 0, the information used to generate the MIC is simultaneous authentication of equals (SAE) authentication and key management protocol (AKMP) data; when the control value is 1, the information used to generate the MIC is Fast Transition (FT) AKMP data; and when the control value is 2, the information used to generate the MIC is Fast Initial Link Setup (FILS) shared key data.

The association request frame may be a re-association request frame, and the STA is a roaming STA.

In addition, the invention further provides a management frame for an association procedure between a client device (STA) and an access point (AP) comprising: a message integrity check element, comprising: an element ID field; a length field; a MIC control value field; and a MIC field. The MIC is calculated according to at least a Pairwise Transient Key (PTK) generated during an authentication procedure between the STA and the AP, and stored in the form of PTKSA, enabling it to be further used during roaming or re-association.

The MIC is calculated by calculating a hash of the association request frame using group data, cipher data and authentication and key management data, and the MIC is generated according to the calculated hash and the PTK. A control value is generated according to the type of data used to generate the MIC, and the control value is written into the MIC control value field. When the control value is 0, the information used to generate the MIC is simultaneous authentication of equals (SAE) authentication and key management protocol (AKMP) data; when the control value is 1, the information used to generate the MIC is Fast Transition (FT) AKMP data; and when the control value is 2, the information used to generate the MIC is Fast Initial Link Setup (FILS) shared key data.

The management frame may be an association request frame, an association response frame, a re-association request frame or a re-association response frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a related art diagram illustrating a roaming STA re-associating to a first AP within a WLAN.

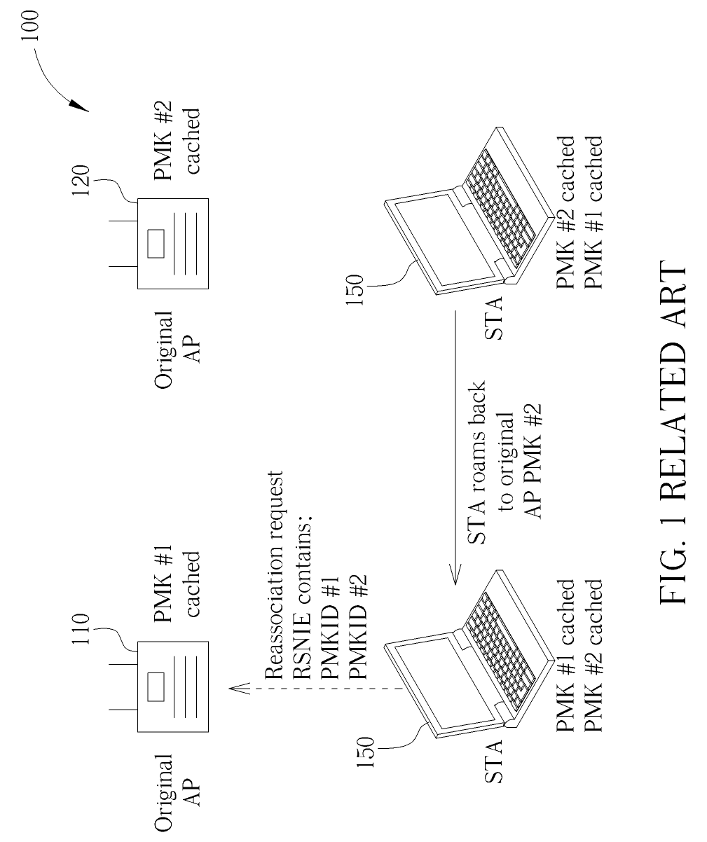

FIG. 2 is a diagram illustrating an MIC element in an association frame according to an exemplary embodiment of the present invention.

### DETAILED DESCRIPTION

In order to address the problems identified in the background, the invention aims to utilize the Pairwise Transient Key (PTK) generated during the authentication stage to generate a MIC which can be sent in the association request/response frames. This allows both the AP and STA to validate the MIC such that the EAPOL handshaking stage will only be entered if the STA is valid. Man in the middle attacks can thereby be identified at the association stage. Moreover, after the STA starts to communicate with the AP, if the STA roams to a different AP and then re-associates with the initial AP, the MIC will also be used in the re-association request/response frames, by using a previously generated PTK which has been stored as PTKSA. This prevents the need for an SA query procedure to be entered when the roaming STA wishes to re-associate to an AP.

In order to generate the MIC for an association request/response, a hash (crypto algorithm) of the frame body will be calculated using Authentication Key Management (AKM) suites, group data suites and cipher suites. The MIC can then be generated by combining the generated hash and the PTK previously obtained in the authentication stage. The MIC is then appended to the association request/response frame.

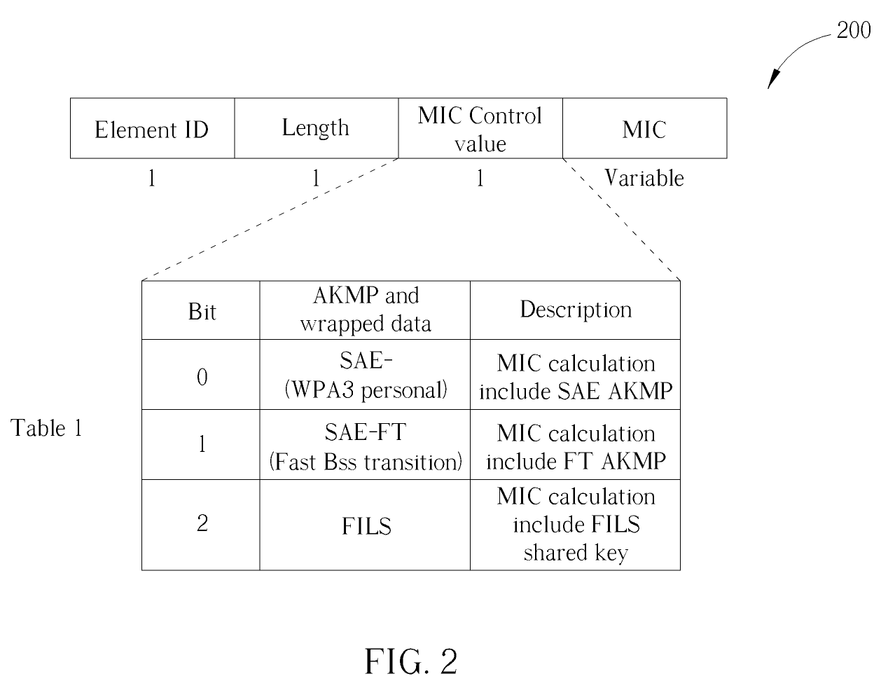

Refer to FIG. 2, which illustrates a MIC element for a management frame according to an exemplary embodiment of the invention. As illustrated in the diagram, the MIC element comprises an element ID field, a length field, a MIC control value field and a MIC field. The MIC tag ID, length and value are standard parts of the MIC element typically included in authentication frames. The present invention provides the MIC control value field, which contains a bit value indicating which type of data has been used to generate the MIC.

Refer to Table 1, which illustrates the content of the MIC control value field. As shown in the table, the bit value can be 0, 1 or 2. A bit value of 0 indicates that simultaneous authentication of equals (SAE) authentication and key management protocol (AKMP) data has been used to calculate the MIC. A bit value of 1 indicates that Fast Transition (FT) AKMP data has been used to calculate the MIC. A bit value of 2 indicates that Fast Initial Link Setup (FILS) shared key data has been used to calculate the MIC.

By accessing the value in the MIC control value field of the association request received by the AP, the AP can thereby derive the MIC using the stored PTK, the hash of the frame and the MIC control value present in the frame. When the MIC control value is 0, SAE data is used to calculate the MIC, when the MIC control value is 1, FT AKMP data is used to calculate the MIC, and when the MIC control value is 2, FILS shared key data is used to calculate the MIC. If the association request is a spoofed request then the content of the frame (the hash) will be different, such that the correct MIC cannot be duplicated. The AP can quickly determine whether a received association request comes from a valid STA, and if said association request is determined to come from an invalid STA, the frame can be dropped and the association procedure will not proceed to the EAPOL handshaking stage. In addition, the AP will not send the association response frame, which further saves network latency.

If the association request is determined to come from a valid STA, the AP can send an association response. The AP will also generate a MIC for the association response frame, similarly using a hash of the frame, the previously generated PTK and also the same type of data used to calculate the MIC in the association request frame. A MIC element as illustrated in FIG. 2 will be appended to the association response frame, wherein the number in the control value field will be the same as in the association request frame. In this way, the STA can also validate the AP; thereby, 2-way spoofing is prevented.

By appending the MIC to the association request and response frames, the EAPOL handshaking stage will only be entered when both the STA and AP are valid such that network latency will not be increased.

The same technique can be used for association for a roaming STA. When an STA roams between APs and sends a re-association request to an AP, the MIC tag can be generated in the same way and appended to the re-association request. The SA query procedure does not need to be entered as the AP can directly use the MIC in the re-association request to determine that the STA is a valid STA. At the AP end, the AP generates the MIC and validates the MIC from the STA by determining whether the MIC generated by the AP is equal to the MIC received from the STA. Similarly, if the re-association request is a spoofed request, this can be directly determined from the content of the frame without the need for an SA query. When sending the re-association response, the AP can also generate the MIC and append it to the frame, such that the STA can determine the AP is valid.

The valid STA will have appended a MIC to the STA association frame. When a man in the middle attack occurs on the association frame sent by the STA, the attacker will change or spoof the contents of the frame. When the AP receives the altered frame, the AP will calculate the MIC for that frame, which will be different from the MIC initially generated by the STA. The AP therefore directly discards the packet without sending as association response to the STA.

By using PTKs generated during the authentication stage to generate MICs and adding a MIC element to association frames, spoofing attacks during an association or re-association stage can quickly be identified, and frames from invalid devices can be discarded without the need to enter a handshaking stage or an SA query procedure. Thus, network resources and latency are improved, and time-sensitive applications can quickly be performed.

An example of a time-sensitive application is opening an electronic lock on a door using a mobile/handheld device. The electronic lock is wirelessly connected with an access point (AP). In order to operate the electronic lock, the mobile device (STA) must connect with the AP. If there is any delay due to spoofed attacks or delays in validating the STA, the electronic lock will not open which can inconvenience a user. By not responding to spoofed frames and validating the STA before the EAPOL handshake stage is entered, valuable time can be saved and user experience is significantly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for associating a client device (STA) with an access point (AP), comprising:
utilizing the STA to generate a message integrity check (MIC) for an association request frame according to at least a Pairwise Transient Key (PTK) generated during an authentication procedure between the STA and the AP;
appending the generated MIC to the association request frame, and sending the association request frame to the AP; and
utilizing the AP to validate the STA according to the MIC in the association request frame.

2. The method of claim 1, further comprising:
when the STA is validated by the AP, utilizing the AP to generate a message integrity check (MIC) for an association response frame according to at least a Pairwise Transient Key (PTK) generated during the authentication procedure between the STA and the AP;
appending the generated MIC to the association response frame, and sending the association response frame to the STA; and
utilizing the STA to validate the AP according to the MIC in the association response frame.

3. The method of claim 1, wherein the step of utilizing the STA to generate the message integrity check (MIC) further comprises:
calculating a hash of the association request frame using group data, cipher data and authentication and key management data;
generating the MIC according to the calculated hash and the PTK;
generating a control value according to the type of data used to generate the MIC; and
including the control value in the association request frame;
wherein the AP uses the control value and the MIC to validate the STA.

4. The method of claim 3, wherein when the control value is 0, the information used to generate the MIC comprises simultaneous authentication of equals (SAE) authentication and key management protocol (AKMP) data; when the control value is 1, the information used to generate the MIC comprises Fast Transition (FT) AKMP data; and when the control value is 2, the information used to generate the MIC comprises Fast Initial Link Setup (FILS) shared key data.

5. The method of claim 1, wherein the association request frame is a re-association request frame, and the STA is a roaming STA.

6. A management frame for an association procedure between a client device (STA) and an access point (AP) comprising:
a message integrity check element, comprising:
an element ID field;
a length field;
a MIC control value field; and
a MIC field.

7. The management frame of claim 6, wherein the MIC is calculated according to at least a Pairwise Transient Key (PTK) generated during an authentication procedure between the STA and the AP.

8. The management frame of claim 7, wherein the MIC is calculated by calculating a hash of the association request frame using group data, cipher data and authentication and key management data, and the MIC is generated according to the calculated hash and the PTK.

9. The management frame of claim 8, wherein a control value is generated according to the type of data used to generate the MIC, and the control value is written into the MIC control value field.

10. The management frame of claim 9, wherein when the control value is 0, the information used to generate the MIC comprises simultaneous authentication of equals (SAE) authentication and key management protocol (AKMP) data; when the control value is 1, the information used to generate the MIC comprises Fast Transition (FT) AKMP data; and when the control value is 2, the information used to generate the MIC comprises Fast Initial Link Setup (FILS) shared key data.

11. The management frame of claim 6 being an association request frame, an association response frame, a re-association request frame or a re-association response frame.
